(19) United States
(12) Patent Application Publication
(10) Pub. No.: US 2005/0200565 A1
(43) Pub. Date: Sep. 15, 2005

(54) Method for driving display panel

(75) Inventor: Hideto Nakamura, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/075,037

(22) Filed: Mar. 9, 2005

(30) Foreign Application Priority Data
Mar. 10, 2004 (JP) 2004-67301

(51) Int. Cl. G09G 3/28

(52) U.S. Cl. 345/60

(57) ABSTRACT

A driving method of a display panel having a resetting step, an addressing step, and a sustaining step in each display cell. The resetting step includes a first step of individually applying a first reset pulse whose voltage value increases with the elapse of time to each of the row electrode pairs to cause a first resetting discharge between the row electrode pairs and a second step of applying an erasing pulse whose voltage value decreases with the elapse of time to one of the row electrode pair to cause an erasing discharge between the row electrode pairs. An electric potential of one of the row electrodes which is reached by applying the erasing pulse is equal to an electric potential in the one row electrode in the addressing step when the scanning pulse is applied.

### BACKGROUND OF THE INVENTION

1. Field of the Invention

The present invention relates to a method for driving a display panel such as a plasma display panel.

2. Description of the Related Arts

A plasma display panel (PDP) has: a plurality of row electrode pairs forming display lines; and a plurality of column electrodes which are arranged so as to cross the row electrode pairs and form display cells in respective crossing portions with the row electrode pairs. The PDP is driven at every period of one field (frame) or at every period of each of subfields obtained by further dividing the 1-field period. The driving period is separated into: a resetting step of executing a resetting discharge to initialize each display cell; an addressing step of executing an addressing discharge by a scanning pulse for the purpose of addressing to set each display cell to either a light-emitting mode or a non-light-emitting mode in accordance with an input video signal; and a sustaining step of executing a sustaining discharge to sustain the light emission of the display cell which has been set into the light-emitting mode.

According to the method disclosed in the Official Gazette of Japanese Patent No. 3025598 as a conventional driving method of the PDP, the resetting step is constructed by an all-writing step and an all-erasing step. That is, in the all-writing step, an all-writing pulse (reset pulse) is applied to each of all of the row electrode pairs, a discharge is caused between the row electrodes of each display cell, and wall charges are formed. In the all-erasing step, an all-erasing pulse is applied to one of the row electrode pair of each display cell, an erasing discharge is caused, and a wall charge amount is reduced. The wall charges which are effective to the addressing discharge by the scanning pulses in the addressing step are, therefore, enabled to remain.

In the conventional driving method, however, since a voltage of the all-erasing pulse and a voltage of the scanning pulse in the addressing period are individually set, there is such a problem that an address margin in the addressing step decreases and an erroneous discharge is liable to occur in the display cell in which the addressing discharge is unnecessary.

### OBJECTS AND SUMMARY OF THE INVENTION

It is, therefore, an object of the invention to provide a driving method of a display panel which can prevent an erroneous discharge by increasing an address margin in an addressing step.

According to the invention, there is provided a method for driving a display panel having a plurality of row electrode pairs forming display lines and a plurality of column electrodes which are arranged so as to cross the row electrode pairs and form display cells in respective crossing portions with the row electrode pairs, wherein in each of the display cells, the driving method comprises: a resetting step of executing a resetting discharge; an addressing step of selectively executing an addressing discharge by applying a scanning pulse to one row electrode of each of the row electrode pairs after completion of the resetting step; and a sustaining step of executing a sustaining discharge after completion of the addressing step, the resetting step includes a first step of individually applying a first reset pulse whose voltage value increases with the elapse of time to each of the row electrode pairs so as to cause a first resetting discharge between the row electrode pairs and a second step of applying an erasing pulse whose voltage value decreases with the elapse of time to one row electrode of each of the row electrode pairs so as to cause an erasing discharge between the row electrode pairs, and an electric potential of the one row electrode which is reached by applying the erasing pulse is equal to an electric potential of the one row electrode in the addressing step when the scanning pulse is applied.

According to the invention, there is provided a method for driving a display panel having a plurality of row electrode pairs forming display lines and a plurality of column electrodes which are arranged so as to cross the row electrode pairs and form display cells in respective crossing portions with the row electrode pairs, wherein in each of the display cells, the driving method comprises: a resetting step of executing a resetting discharge; an addressing step of selectively executing an addressing discharge by applying a scanning pulse to one row electrode of each of the row electrode pairs after completion of the resetting step; and a sustaining step of executing a sustaining discharge after completion of the addressing step, the resetting step includes a first step of individually applying a first reset pulse whose voltage value increases with the elapse of time to each of the row electrode pairs so as to cause a first resetting discharge between the row electrode pairs and a second step of applying an erasing pulse whose voltage value decreases with the elapse of time to one row electrode of each of the row electrode pairs so as to cause an erasing discharge between the row electrode pairs, and an electric potential of the one row electrode in the addressing step when the scanning pulse is applied is changed together with an electric potential of the one row electrode which is reached by applying the erasing pulse.

### BRIEF DESCRIPTION OF THE DRAWINGS

FIG. 1 is a block diagram showing a construction of a display apparatus to which a driving method of the invention is applied;

FIG. 2 is a circuit diagram showing a specific construction in each row electrode driving circuit for a display cell CS; and

FIG. 3 is a time chart showing the operation of each unit in the circuit of FIG. 2.

### DETAILED DESCRIPTION OF THE PREFERRED EMBODIMENT

An embodiment of the invention will be described in detail hereinbelow with reference to the drawings.

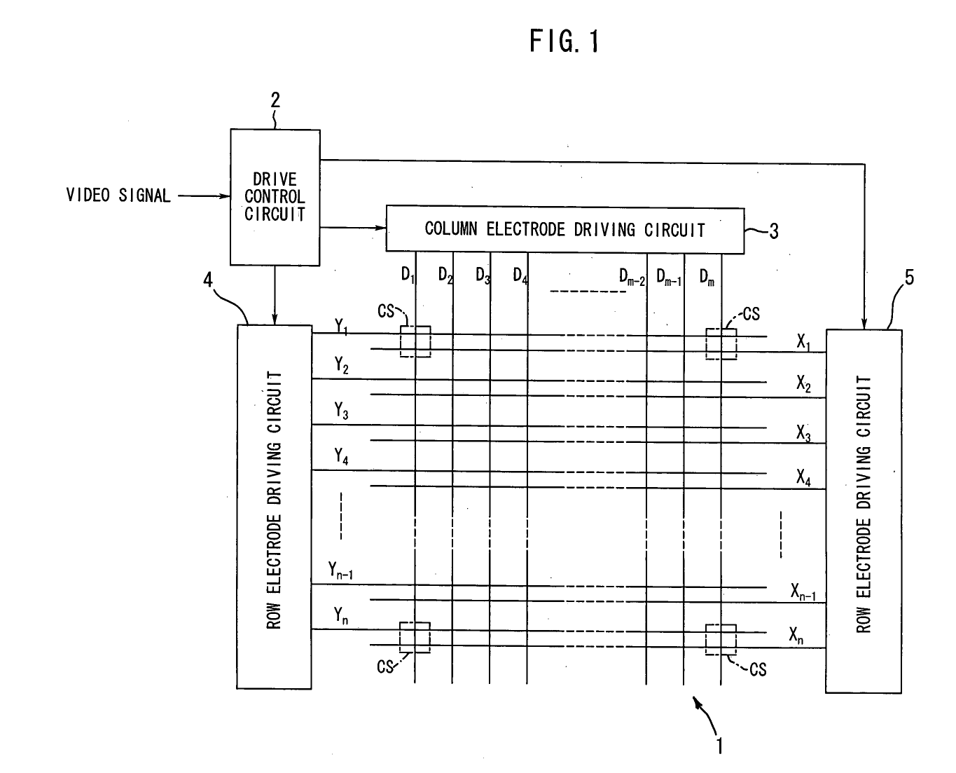

FIG. 1 shows a display apparatus to which a driving method of a plasma display panel according to the invention is applied. The display apparatus is constructed by a PDP 1; a drive control circuit 2; a column electrode driving circuit 3; and row electrode driving circuits 4 and 5.

The PDP 1 has row electrodes Y₁ to Yₙ and X₁ to Xₙ. Each of the first to nth display lines of a display screen is formed by a pair of electrodes X and Y. Column electrodes D₁ to Dₘ corresponding to the first to mth columns of the display screen are further formed on the PDP 1 so as to perpendicularly cross the row electrodes Y₁ to Yₙ and X₁ to Xₙ and sandwich a dielectric layer (not shown) and a discharge space (not shown). A display cell CS serving as a pixel is formed in each crossing portion of the row electrodes Y₁ to Yₙ and X₁ to Xₙ and the column electrodes D₁ to Dₘ. Although only four display cell CS are shown in the diagram, the display cells are formed in all crossing portions.

The drive control circuit 2 forms various timing signals to gradation-drive the PDP 1 on the basis of a subfield method and supplies them to the row electrode driving circuits 4 and 5. The drive control circuit 2 divides pixel data of each pixel based on an input video signal every bit digit, forms pixel data bits DB, and supplies the pixel data bits DB to the column electrode driving circuit 3 every display line (DB₁ to DBₘ).

The column electrode driving circuit 3 generates pixel data pulses in accordance with the pixel data bits DB₁ to DBₘ and applies them to the column electrodes D₁ to Dₘ of the PDP 1.

The row electrode driving circuits 4 and 5 generate various driving pulses in accordance with the various timing signals supplied from the drive control circuit 2 and apply them to one of the row electrodes Y₁ to Yₙ and X₁ to Xₙ of the PDP 1. In the gradation-driving based on the subfield method, one field period in the input video signal is divided into a plurality of subfields and the light-emitting driving to each display cell is executed every subfield.

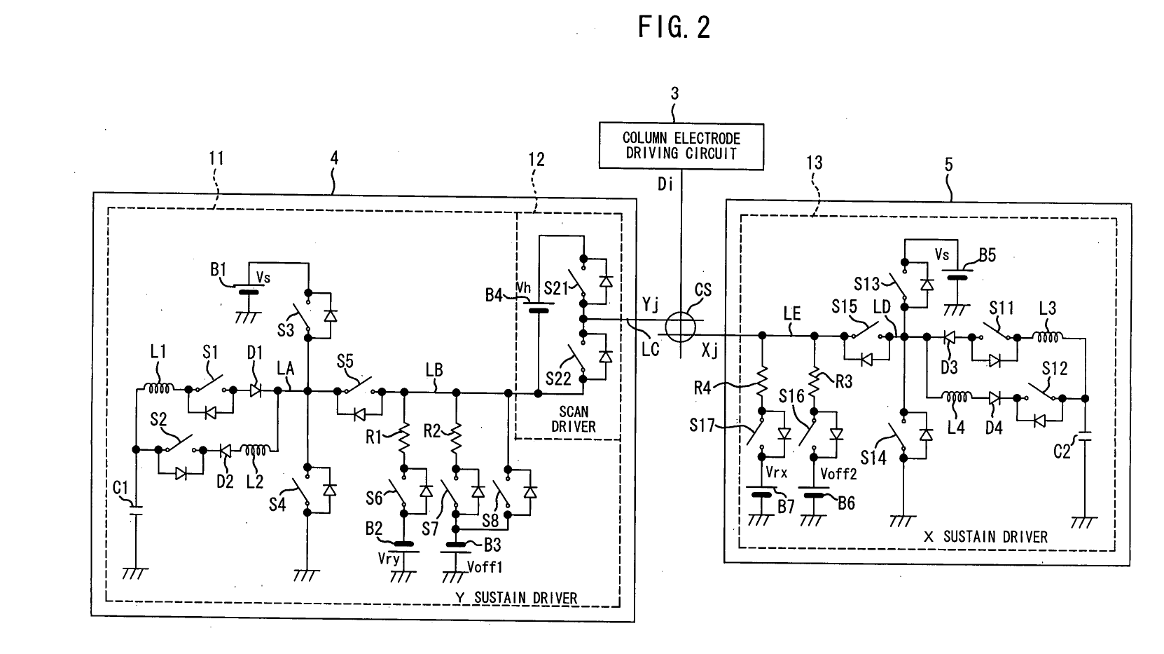

FIG. 2 shows a specific construction in the row electrode driving circuits 4 and 5 to the display cell CS formed in the crossing portions of the column electrode Dᵢ and the row electrodes Yⱼ to Xⱼ of the PDP 1. The row electrode driving circuit 4 has a Y sustain driver 11 and a scan driver 12 for the display cell CS. The row electrode driving circuit 5 has an X sustain driver 13 for the display cell CS.

The Y sustain driver 11 has coils L1 and L2, switching devices S1 to S8, diodes D1 and D2, resistors R1 and R2, a capacitor C1, and power sources B1 to B3.

The scan driver 12 has switching devices S21 and S22 and a power source B4.

The X sustain driver 13 has coils L3 and L4, switching devices S11 to S17, diodes D3 and D4, resistors R3 and R4, a capacitor C2, and power sources B5 to B7.

Each of the switching devices S1 to S8, S11 to S17, S21, and S22 has a parasitic diode as shown by a diode symbol in FIG. 2.

In the Y sustain driver 11, a positive terminal of the power source B1 is connected to a connection line LA through the switching device S3 and a negative terminal is connected to the ground. The power source B3 generates a voltage Vs. The switching device S4 is connected between the connection line LA and the ground. A series circuit comprising the diode D1, the switching device S1, and the coil L1 and a series circuit comprising the coil L2, the diode D2, and the switching device S2 are connected to the ground through the capacitor C1 in common. The diode D1 is connected so that the capacitor C1 side is set to an anode. The diode D2 is connected so that the capacitor C1 side is set to a cathode.

The connection line LA is connected to a connection line LB connecting to a negative terminal of the power source B4 of the scan driver 12 through the switching device S5.

A negative terminal of the power source B2 is connected to the connection line LB through the switching device S6 and the resistor R1 and a positive terminal is connected to the ground. Similarly, a negative terminal of the power source B3 is connected to the connection line LB through the switching device S7 and the resistor R2 and a positive terminal is connected to the ground. The negative terminal of the power source B3 is connected to the connection line LB only through the switching device S8.

The power source B2 generates a voltage Vry and the power source B3 generates a voltage Voff1. The power source B4 generates a voltage Vh (Vh<Vs).

In the scan driver 12, a positive terminal of the power source B4 is connected to a connection line LC connecting to the electrode Yⱼ through the switching device S21. The negative terminal of the power source B4 connected to the connection line LB is connected to the connection line LC through the switching device S22.

The ON/OFF operations of the switching devices S1 to S8, S21, and S22 are controlled in accordance with the timing signals generated from the drive control circuit 2.

In the X sustain driver 13, a positive terminal of the power source B5 is connected to a connection line LD through the switching device S13 and a negative terminal is connected to the ground. The power source B5 generates the voltage Vs. The switching device S14 is connected between the connection line LD and the ground. A series circuit comprising the diode D3, the switching device S11, and the coil L3 and a series circuit comprising the coil L4, the diode D4, and the switching device S12 are connected to the ground through the capacitor C2 in common. The diode D3 is connected so that the capacitor C2 side is set to an anode. The diode D4 is connected so that the capacitor C2 side is set to a cathode.

The connection line LD is connected to a connection line LE connecting to the electrode Xⱼ through the switching device S15.

A positive terminal of the power source B6 is connected to the connection line LE through the switching device S16 and the resistor R3 and a negative terminal is connected to the ground. Similarly, a positive terminal of the power source B7 is connected to the connection line LE through the switching device S17 and the resistor R4 and a negative terminal is connected to the ground.

The power source B6 generates a voltage Voff2. The power source B7 generates a voltage Vrx.

The ON/OFF operations of the switching devices S11 to S17 are controlled in accordance with the timing signals generated from the drive control circuit 2.

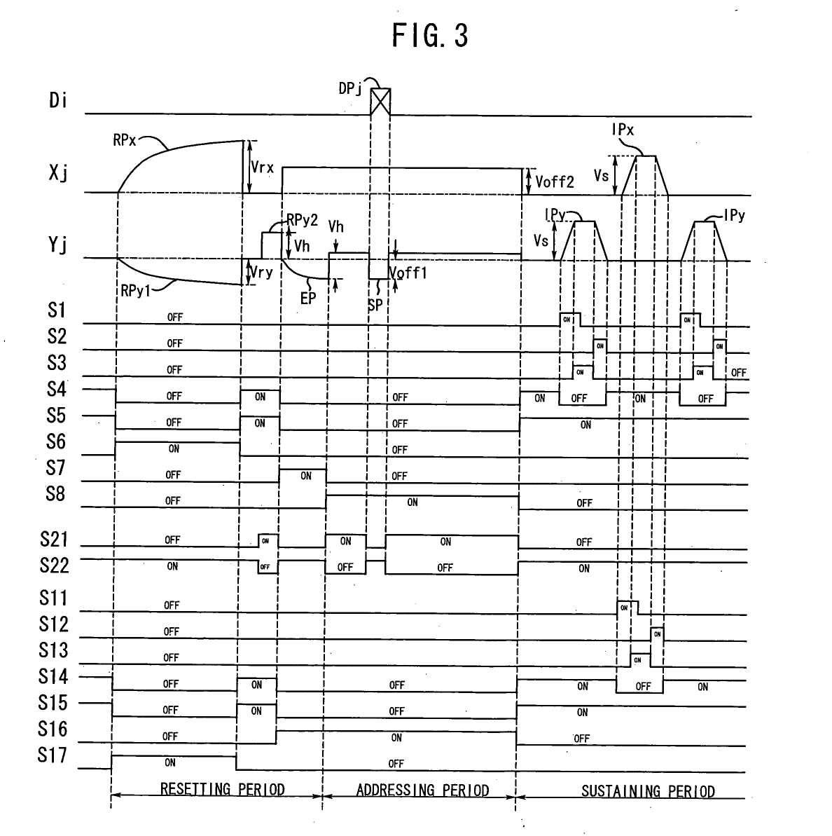

The operation of the display apparatus with the construction will now be described with reference to a time chart of FIG. 3. The time chart of FIG. 3 shows only the first subfield. The operation of the display apparatus comprises a resetting period for executing a resetting step, an addressing period for executing an addressing step, and a sustaining period for executing a sustaining step. A write addressing system is applied in the operation.

First, when the resetting period is started, the switching device S6 of the Y sustain driver 11 is turned on. The other switching devices of the Y sustain driver 11 are OFF. At this time, the switching device S21 of the scan driver 12 is OFF and the switching device S22 is ON. In the X sustain driver 13, the switching device S17 is turned on for the resetting period. A current flows from the positive terminal of the power source B7 to the electrode Xⱼ through the switching device S17 and the resistor R4. The current further flows between the electrodes Xⱼ and Yⱼ and flows from the electrode Yⱼ to the negative terminal of the power source B2 through the switching device S22, the resistor R1, and the switching device S6. Since a space between the electrodes Xⱼ and Yⱼ can be regarded as a capacitor, an electric potential of the electrode Xⱼ increases gradually to the positive side, reaches Vrx, and becomes a reset pulse RPx. An electric potential of the electrode Yⱼ increases gradually to the negative side, reaches −Vry, and becomes a first reset pulse RPy1. A discharge current flows between the electrodes Xⱼ and Yⱼ and charge particles are generated. After termination of the discharge, a predetermined amount of wall charges are uniformly formed in the dielectric layer of the display cell.

The switching devices S6 and S17 are turned off after levels of the reset pulses RPy1 and RPx are saturated. At the OFF time point, the switching devices S4, S5, S14, and S15 are turned off and both of the electrodes Xⱼ and Yⱼ are connected to the ground. The reset pulses RPx and RPy are, consequently, extinguished.

After that, the switching device S21 of the scan driver 12 is turned on and the switching device S22 is turned off. The output voltage Vh of the power source B4 is applied to the electrode Yⱼ through the switching device S21 and becomes a second reset pulses RPy2. Since the second reset pulses RPy2 is applied, an amount of wall charges is adjusted.

When the second reset pulse RPy2 is applied for a predetermined period, the switching devices S4, S5, S14, and S15 are turned off and the switching devices S7 and S16 are turned on. At the same time, the switching device S21 of the scan driver 12 is turned off and the switching device S22 is turned on. A current flows from the positive terminal of the power source B6 to the electrode Xⱼ through the switching device S16 and the resistor R3. The current further flows between the electrodes Xⱼ and Yⱼ and flows from the electrode Yⱼ to the negative terminal of the power source B3 through the switching device S22, the resistor R2, and the switching device S7. The electric potential of the electrode Xⱼ increases immediately to the positive side and reaches Voff2. Since the electric potential of the electrode Yⱼ is influenced by the charges accumulated between the electrodes Xⱼ and Yⱼ by the reset pulse RPy2 it increases gradually to the negative side, reaches −Voff1, and becomes an all-erasing pulse EP. The all-erasing pulse EP causes a discharge between the electrodes Xⱼ and Yⱼ and temporarily decreases the wall charges to a level at which no discharge is caused by applying a sustaining pulse.

After the level of the all-erasing pulse EP is saturated, the switching device S7 is turned off, the switching device S8 is turned on, further, the switching device S21 of the scan driver 12 is turned on, and the switching device S22 is turned off. Since the power sources B4 and B3 are, consequently, serially connected between the electrode Yⱼ and the ground so as to have the opposite polarities, the all-erasing pulse EP is extinguished and the electric potential of the electrode Yⱼ rises immediately from −Voff1 by the amount of Vh. The resetting period is terminated by the potential change of the electrode Yⱼ and the addressing period is started.

At the point of termination of the resetting period, the wall charges of the negative electrode remain on the electrode Xⱼ, the wall charges of the negative electrode remain on the electrode Yⱼ, the wall charges of the positive electrode remain on the electrode Dᵢ, and all of the display cells enter the light-off mode (state where the wall charges between the pair of row electrodes have been saturated) before a selection write address.

In the addressing period, the column electrode driving circuit 3 converts the pixel data of each pixel based on the video signal into pixel data pulses DP₁ to DPₙ each having a voltage value corresponding to its logic level and sequentially applies them to the column electrodes D₁ to Dₘ every row. A pixel data pulse DPⱼ is applied to the electrode Dᵢ in correspondence to an electrode Y^{j}.

The Y sustain driver 11 sequentially applies scanning pulses SP of a negative voltage to the row electrodes Y₁ to Yₙ synchronously with the timing of each of the pixel data pulses DP₁ to DPₙ. The switching device S21 is turned off and the switching device S22 is turned on synchronously with the supply of the pixel data pulse DPⱼ from the column electrode driving circuit 3. The negative potential −Voff of the negative terminal of the power source B3 is, thus, applied as a scanning pulse SP to the electrode Yⱼ through the switching devices S8 and S22.

The switching device S21 is turned on and the switching device S22 is turned off synchronously with the stop of the supply of the pixel data pulse DPⱼ from the column electrode driving circuit 3. The electric potential (Vh−Voff) of the positive terminal of the power source B4 is applied to the electrode Yⱼ through the switching device S21. After that, in a manner similar to the electrode Yⱼ, the scanning pulses SP are also applied to the electrode Yⱼ₊₁, . . . , and Yₙ in this order synchronously with the supply of the pixel data pulses DPⱼ₊₁, . . . , and DPₙ from the column electrode driving circuit 3.

In the display cells belonging to the row electrodes to which the scanning pulses SP have been supplied, when the pixel data pulses of the positive voltage are further simultaneously applied, a discharge occurs and the amount of wall charges increases to a level at which the discharge is performed by applying the sustaining pulse. Since no discharge occurs in the display cells to which no pixel data pulses of the positive voltage are applied although the scanning pulses SP have been supplied, the wall charge amount does not increase. At this time, the display cell in which the wall charge amount increased becomes a light-emitting display cell and the display cell in which the wall charge amount does not change becomes a non-light-emitting display cell.

When switching from the addressing period to the sustaining period, the switching devices S8, S16, and S21 are turned off and the switching devices S4, S5, S14, S15, and S22 are turned on in place of them.

In the sustaining period, therefore, first, the electric potential of the electrode Yⱼ is set to the ground potential of almost 0V due to the turn-on of the switching devices S4 and S5 of the Y sustain driver 11 and the turn-on of the switching device S22 of the scan driver 12. In the X sustain driver 13, the electric potential of the electrode Xⱼ is set to the ground potential of almost 0V due to the turn-on of the switching devices S14 and S15.

Subsequently, when the switching device S4 is turned off and the switching device S1 is turned on, the current reaches the electrode Yⱼ through the coil L1, switching device S1, diode D1, switching device S5, and switching device S22 by the charges accumulated in the capacitor C1, flows in the capacitor component between the electrodes Yⱼ and Xⱼ, and further flows to the ground through the switching devices S15 and S14. The capacitor component between the electrodes Yⱼ and Xⱼ is, therefore, charged. At this time, the electric potential of the electrode Yⱼ rises gradually as shown in FIG. 3 by a time constant of the coil L1 and the capacitor component between the electrodes Yⱼ and Xⱼ.

Subsequently, the switching device S3 is turned on. The electric potential Vs of the positive terminal of the power source B1 is, thus, supplied to the electrodes Yⱼ. Just after that, the switching device S1 is turned off. The switching device S3 is turned on only for a predetermined period. After the elapse of the predetermined period, the switching device S3 is turned off and, at the same time, the switching device S2 is turned on. The current flows into the capacitor C1 from the electrode Yⱼ through the switching device S22, switching device S5, coil L2, diode D2, and switching device S2 by the charges accumulated in the capacitor component between the electrodes Yⱼ and Xⱼ. At this time, the electric potential of the electrode Yⱼ decreases gradually as shown in FIG. 3 by a time constant of the coil L2 and the capacitor C1. When the electric potential of the electrode Yⱼ reaches almost 0V, the switching device S2 is turned off and the switching device S4 is turned on.

By the operation, the Y sustain driver 11 applies a sustaining pulse IPy of the positive voltage as shown in FIG. 3 to the electrode Yⱼ.

In the X sustain driver 13, after the sustaining pulse IPy is extinguished, the switching device S11 is turned on and the switching device S14 is turned off. When the switching device S14 is ON, the electric potential of the electrode Xⱼ is equal to the ground potential of almost 0V. When the switching device S14 is turned off and the switching device S11 is turned on, however, the current reaches the electrode Xⱼ through the coil L3, switching device S11, diode D3, and switching device S15 by the charges accumulated in the capacitor C2, flows into the capacitor component between the electrodes Xⱼ and Yⱼ, and further flows to the ground through the switching devices S22, S5, and S4. The capacitor component between the electrodes Xⱼ and Yⱼ is, therefore, charged. At this time, the electric potential of the electrode Xⱼ rises gradually as shown in FIG. 3 by the time constant of the coil L3 and the capacitor component between the electrodes Xⱼ and Yⱼ.

The switching device S13 is subsequently turned on. The electric potential Vs of the positive terminal of the power source B5 is, thus, applied to the electrode Xⱼ. The switching device S11 is turned off just after that. The switching device S13 is ON only for a predetermined period and is turned off after the elapse of the predetermined period. At the same time, the switching device S12 is turned on and the current flows into the capacitor C2 from the electrode Xⱼ through the switching device S15, coil L4, diode D4, and switching device S12 by the charges accumulated in the capacitor component between the electrodes Xⱼ and Yⱼ. In this instance, the electric potential of the electrode Xⱼ decreases gradually as shown in FIG. 3 by the time constant of the coil L4 and the capacitor C2. When the electric potential of the electrode Xⱼ reaches almost 0V, switching device S12 is turned off and the switching device S14 is turned on.

By the operation, the X sustain driver 13 applies a sustaining pulse IPx of the positive voltage as shown in FIG. 3 to the electrode Xⱼ. In the residual portion of the sustaining period after the supply of the sustaining pulse IPx to the electrode Xⱼ, since the sustaining pulse IPy and the sustaining pulse IPx are alternately formed and alternately supplied to the electrode Yⱼ and the electrode Xⱼ, the light-emitting display cell in which the wall charge amount is increased for the addressing period repeats the discharge light emission and maintains the light-emitting state. The applying timing of the sustaining pulse IPx to the electrode Xⱼ is not limited to that to the electrode Xⱼ but the pulse is simultaneously applied to all of the row electrodes X₁ to Xₙ. The applying timing of the sustaining pulse IPy to the electrode Yⱼ is not limited to that to the electrode Yⱼ but the pulse is simultaneously applied to all of the row electrodes Y₁ to Yₙ.

In the embodiment, the switching device S7 is turned on, the all-erasing pulse EP whose electric potential changes gradually is generated by using the power source B3 for generating the scanning pulse SP, and after that, the power source B3 is also used for generation of the scanning pulse SP. Even if the voltage value of the scanning pulse SP is increased, the arrival voltage value of the all-erasing pulse EP also increases in association with it, so that the erroneous discharge upon addressing can be prevented.

Although the arrival voltage value of the all-erasing pulse EP is equal to the voltage value of the scanning pulse SP in the embodiment, the invention is not limited to it. It is also possible to construct the system in such a manner that the arrival voltage value of the all-erasing pulse EP is not equal to the voltage value of the scanning pulse SP but is merely interlocked with it.

Further, although the second reset pulse RPy2 has been generated in the embodiment, the second reset pulse RPy2 can be omitted. In the case of omitting the second reset pulse RPy2, it is necessary to set the polarities of the reset pulse RPy1 and RPx to be opposite to those in the embodiment.

The first reset pulse RPy1 can be omitted from the embodiment. When omitting the first reset pulse RPy1, in the resetting period, the first reset pulse RPx having a first polarity is applied to the electrodes X₁ to Xₙ, the second reset pulse RPy2 having the first polarity is applied to the electrodes Y₁ to Yₙ, and then the all-easing pulse EP is applied to the electrodes Y₁ to Yₙ, in that application order as shown in FIG. 3.

According to the invention as mentioned above, since the electric potential of one of the row electrodes which is reached by the supply of the erasing pulse is equal to or is interlocked with the electric potential when the scanning pulse is supplied to one of the row electrodes in the addressing step, the address margin in the addressing step can be increased and the erroneous discharge is prevented.

This application is based on a Japanese Application No. 2004-67301 which is hereby incorporated by reference.

1. A method for driving a display panel having a plurality of row electrode pairs forming display lines and a plurality of column electrodes which are arranged so as to cross said row electrode pairs and form display cells in respective crossing portions with said row electrode pairs, wherein
in each of said display cells, the driving method comprises: a resetting step of executing a resetting discharge; an addressing step of selectively executing an addressing discharge by applying a scanning pulse to one row electrode of each of said row electrode pairs after completion of said resetting step; and a sustaining step of executing a sustaining discharge after completion of said addressing step,
said resetting step includes a first step of individually applying a first reset pulse whose voltage value increases with the elapse of time to each of said row electrode pairs so as to cause a first resetting discharge between said row electrode pairs and a second step of applying an erasing pulse whose voltage value decreases with the elapse of time to one row electrode of each of said row electrode pairs so as to cause an erasing discharge between said row electrode pairs, and
an electric potential of the one row electrode which is reached by applying said erasing pulse is equal to an electric potential of the one row electrode in said addressing step when said scanning pulse is applied.

2. A method according to claim 1, wherein a wall charge of a predetermined polarity are formed between electrodes for each of said row electrode pairs by said first resetting discharge and an amount of the wall charge formed between the electrodes are decreased by said erasing discharge.

3. A method according to claim 1, wherein said resetting step includes a step of applying a second reset pulse of a polarity opposite to that of said first resetting pulse applied to said one row electrode, to said one row electrode for a period of time until said erasing pulse is applied after said first resetting pulse has been applied.

4. A method for driving a display panel having a plurality of row electrode pairs forming display lines and a plurality of column electrodes which are arranged so as to cross said row electrode pairs and form display cells in respective crossing portions with said row electrode pairs,
wherein in each of said display cells, said driving method comprises: a resetting step of executing a resetting discharge; an addressing step of selectively executing an addressing discharge by applying a scanning pulse to one row electrode of each of said row electrode pairs after completion of said resetting step; and a sustaining step of executing a sustaining discharge after completion of said addressing step,
said resetting step includes a first step of individually applying a first reset pulse whose voltage value increases with the elapse of time to each of said row electrode pairs so as to cause a first resetting discharge between said row electrode pairs and a second step of applying an erasing pulse whose voltage value decreases with the elapse of time to one row electrode of each of said row electrode pairs so as to cause an erasing discharge between said row electrode pairs, and
an electric potential of the one row electrode in said addressing step when said scanning pulse is applied is changed together with an electric potential of said one row electrode which is reached by applying said erasing pulse.
